(19) United States
(12) Patent Application Publication
(10) Pub. No.: US 2004/0061893 A1
(43) Pub. Date: Apr. 1, 2004

(54) Image forming apparatus

(76) Inventor: Shinichiroh Wada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/608,112

(22) Filed: Jun. 30, 2003

(30) Foreign Application Priority Data
Jul. 2, 2002 (JP) 2002-193658

(51) Int. Cl. B41F 1/00; G06F 15/00; H04N 1/00

(52) U.S. Cl. 358/1.15; 358/401

(57) ABSTRACT

There is provided an image forming apparatus including a digital printing device that prints an image according to image signals and a digital scanning device, connectable to the digital printing device, that scans an image and converts the image into electric signals. The digital printing device includes a first nonvolatile memory for storing first parameters that optimize performance of the digital printing device. The digital scanning device includes a second nonvolatile memory for storing second parameters that optimize performance of the digital scanning device. The digital printing device includes a section for modifying the second parameters when the digital scanning device is connected to the digital printing device.

### BACKGROUND OF THE INVENTION

1. Field of the Invention

The present invention relates to an image forming apparatus, such as a printer, a copier, a fax machine.

2. Description of the Related Art

A digital duplicating machine may have functions of a digital scanner and a digital printer, and a digital duplicating machine may even be formed by including both a digital scanner portion and digital printer portion. Digital scanners and digital printers have their own characteristic parameters, with which they are set to work at the best performance. For example, in a digital duplicating machine including a digital scanner portion and digital printer portion, the characteristic parameters of the digital scanner and digital printer are determined when they are fabricated in the factory and are usually stored in a non-volatile memory installed in the digital printer which usually works under sequential control.

Even when a digital scanner and a digital printer are fabricated separately, furthermore, even after the digital scanner and the digital printer are shipped, for example, when they are in distribution, it is still possible to realize a digital duplicating machine by just connecting the digital scanner to the digital printer. In, this case, because the digital scanner and the digital printer are fabricated separately, the characteristic parameters of the digital scanner and the digital printer are originally stored in their own non-volatile memories. In this case, because generally the digital scanner and the digital printer include built-in micro-computers to control their respective operations, the micro-computers may communicate with each other to realize the function of a duplicating machine.

However, when a digital scanner and a digital printer fabricated separately are connected later, the characteristic parameters of the digital scanner have to be modified to fit the overall performance of the digital duplicating machine. In this case, there arises a problem of management of the characteristic parameters, and this problem may make it difficult to realize the function of a digital duplicating machine.

### SUMMARY OF THE INVENTION

Accordingly, it is a general object of the present invention to solve the above problem of the related art.

A first specific object of the present invention is to provide an image recording apparatus able to realize a function of a digital duplicating machine by connecting a digital scanning device to a digital printing device even when the digital scanning device and the digital printing device are in distribution.

A second specific object of the present invention is to provide an image recording apparatus able to ensure the performance of a digital scanning device and manage characteristic parameters of the digital scanning device from a digital printing device.

A third specific object of the present invention is to provide an image recording apparatus able to ensure the performance of a digital scanning device, manage characteristic parameters of the digital scanning device from a digital printing device, and maintain compatibility even when a different digital scanning device is connected to the digital printing device.

A fourth specific object of the present invention is to provide an image recording apparatus able to ensure the performance of a digital scanning device, and maintain compatibility even when the digital scanning device is newly connected or the digital scanning device is connected to a different digital printing device.

A fifth specific object of the present invention is to provide an image recording apparatus able to ensure the performance of a digital scanning device and eliminate the necessity of adjusting characteristic parameters of the digital scanning device even when the digital scanning device is newly connected.

To attain the above objects, according to a first aspect of the present invention, there is provided an image forming apparatus, comprising a digital printing device that prints an image according to image signals input thereto, the digital printing device including a first nonvolatile memory for storing first parameters that optimize performance thereof, and a digital scanning device, connectable to the digital printing device, that scans an image and converts the image into electric signals, the digital scanning device including a second nonvolatile memory for storing second parameters that optimize performance thereof, wherein the digital printing device includes control means for modifying the second parameters when the digital scanning device is connected to the digital printing device.

Preferably, the control means comprise reading means for reading the second parameters stored in the second nonvolatile memory of the digital scanning device when the digital scanning device is connected to the digital printing device, modification means for modifying the second parameters read by the reading means, and writing means for writing the modified second parameters to the second nonvolatile memory of the digital scanning device when the digital scanning device is connected to the digital printing device.

Preferably, the control means comprise reading means for reading the second parameters stored in the second nonvolatile memory of the digital scanning device when the digital scanning device is connected to the digital printing device, modification means for modifying the second parameters read by the reading means, and writing means for writing the modified second parameters to the first nonvolatile memory of the digital printing device and the second nonvolatile memory of the digital scanning device when the digital scanning device is connected to the digital printing device.

Preferably, the control means comprise reading means for reading the second parameters stored in the second nonvolatile memory of the digital scanning device when the digital scanning device is connected to the digital printing device, modification means for modifying the second parameters read by the reading means, and writing means for writing values equal to the modifications made by the modification means to the second nonvolatile memory of the digital scanning device when the digital scanning device is connected to the digital printing device.

Preferably, the control means comprise reading means for reading the second parameters stored in the second nonvolatile memory of the digital scanning device when the digital scanning device is connected to the digital printing device, modification means for modifying the second parameters read by the reading means, and writing means for writing values equal to the modifications made by the modification means to the first nonvolatile memory of the digital printing device and the second nonvolatile memory of the digital scanning device when the digital scanning device is connected to the digital printing device.

To attain the above objects, according to a second aspect of the present invention, there is provided a digital printing device that prints an image according to image signals input thereto, the digital printing device forming an image forming apparatus when connected with a digital scanning device that scans the image and converts the image into the image signals, the digital printing device including a first nonvolatile memory for storing first parameters that optimize performance thereof, and the digital scanning device including a second nonvolatile memory for storing second parameters that optimize performance thereof, the digital printing device comprising control means for modifying the second parameters when the digital scanning device is connected to the digital printing device.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a block diagram showing a hardware configuration of an image forming apparatus according to a first embodiment of the present invention;

FIGS. 2A and 2B are views of memory maps of the EEPROM 18 and NVRAM 25 of the image forming apparatus according to the first embodiment of the present invention;

FIG. 3 is a flow chart showing an example of the operation of the image forming apparatus according to the first embodiment of the present invention;

FIGS. 4A and 4B are views of memory maps of the EEPROM 18 and NVRAM 25 of an image forming apparatus according to a second embodiment of the present invention;

FIG. 5 is a flow chart showing an example of the operation of the image forming apparatus according to the second embodiment of the present invention;

FIG. 6 is a flow chart showing another example of the operation of the image forming apparatus according to the second embodiment of the present invention;

FIG. 7 is a flow chart showing an example of the operation of an image forming apparatus according to a third embodiment of the present invention;

FIGS. 8A and 8B are views of memory maps of the EEPROM 18 and NVRAM 25 of an image forming apparatus according to a fourth embodiment of the present invention;

FIG. 9 is a flow chart showing an example of the operation of the image forming apparatus according to the fourth embodiment of the present invention;

FIGS. 10A and 10B are views of memory maps of the EEPROM 18 and NVRAM 25 of an image forming apparatus according to a fifth embodiment of the present invention;

FIG. 11 is a flow chart showing an example of the operation of the image forming apparatus according to the fifth embodiment of the present invention;

FIGS. 12A and 12B are views of memory maps of the EEPROM 18 and NVRAM 25 of an image forming apparatus according to a sixth embodiment of the present invention; and

FIG. 13 is a flow chart showing an example of the operation of the image forming apparatus according to the sixth embodiment of the present invention.

### DESCRIPTION OF THE PREFERRED EMBODIMENTS

Below, preferred embodiments of the present invention are explained with reference to the accompanying drawings.

In the following descriptions, as an example, the nonvolatile storage medium may be an NVRAM (NonVolatile Random Access Memory), which includes a power supply, or an EEPROM (Electrically Erasable Programmable Read-Only Memory), or an OTPROM (One Time Programmable Read-Only Memory), or a PROM (Programmable Read-Only Memory).

First Embodiment

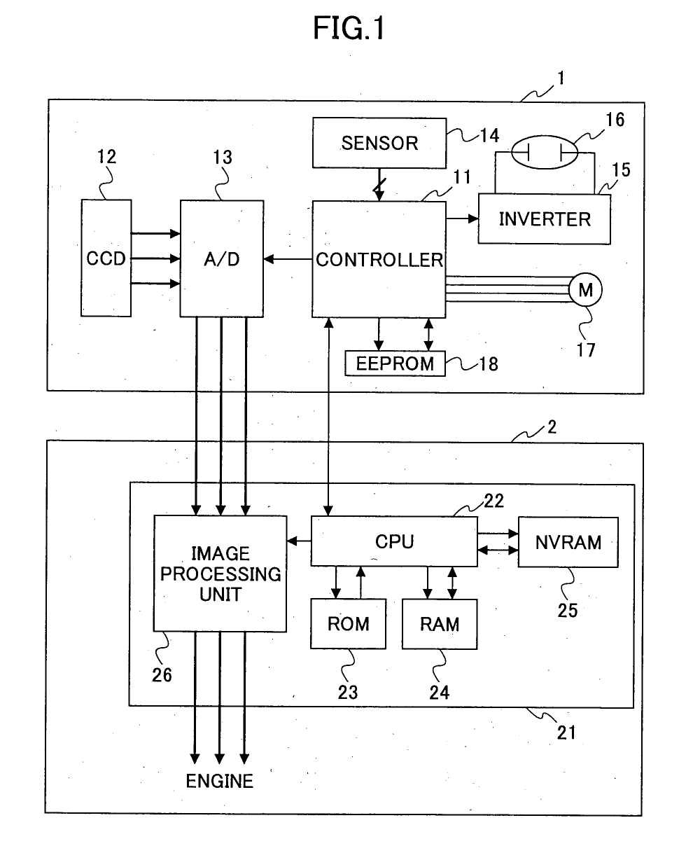

FIG. 1 is a block diagram showing a hardware configuration of an image forming apparatus according to a first embodiment of the present invention.

The image forming apparatus according to the first embodiment of the present invention includes a digital scanner 1 and a digital printer 2 connected to each other, thus having the function of a digital duplicating machine. The digital scanner 1 has an EEPROM 18, and the digital printer 2 has an NVRAM 25, which are nonvolatile memories.

In the digital scanner 1, a manuscript is placed on a glass window and is irradiated by a lamp 16; when a carriage holding the lamp 16 and an optical system moves, the manuscript is scanned in the sub scan direction; the light reflected from the manuscript or the light transmitted through the manuscript passes through the optical system, and is detected by a CCD 12 that acts as an image sensor; the light detected by the CCD 12 is converted into electrical signals in the CCD 12, and from the image signals, the image on the manuscript is obtained by the digital scanner 1. The image signals are amplified, combined, and are converted into digital signals (A/D conversion) in a signal processing unit 13, and then are output to an image processing unit 26 of the digital printer 2.

The controller 11, which comprises an IC chip, controls all parts of the digital scanner 1; specifically, the controller 11 switches ON or OFF an inverter 15 that drives the lamp 16, drives a motor 17 to move the carriage mentioned above, accepts detection signals from a sensor 14 that detects the movement of the carriage, and accesses the EEPROM 18.

In the digital printer 2, the main control section 21 has a CPU 22 that controls a not-illustrated engine of the digital printer 2 and the controller 11 of the digital scanner 1. The CPU 22 operates according to the program stored in a ROM 23; it controls the digital printer 2 to work as a printer when the digital scanner 1 is not connected to the digital printer 2, and when the digital scanner 1 is connected to the digital printer 2, it controls all the components in the digital printer 2 and the digital scanner 1 so that the digital printer 2 and the digital scanner 1 together work as a digital duplicating machine.

The RAM 24 temporarily stores data generated when the CPU 22 is in operation, and the NVRAM 25 stores characteristic parameters of the digital printer 2. The characteristic parameters of the digital scanner 1 are stored in the EEPROM 18 connected to the controller 11. Those parameters are written to the digital scanner 1 and the digital printer 2, respectively, when they are fabricated in the factory. The image processing unit 26 receives and processes the image signals from the signal processing unit 13, and outputs the image signals to the engine of the digital printer 2. The engine of the digital printer 2 records an image on a medium, such as paper, according to the image signals from the image processing unit 26.

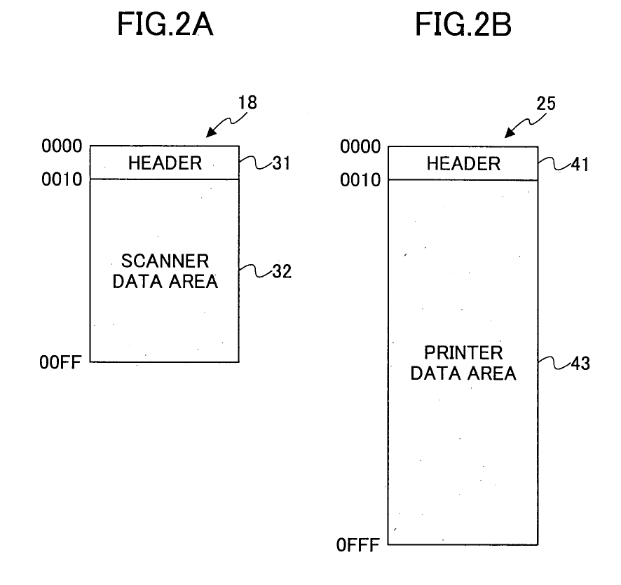

FIGS. 2A and 2B are views of memory maps of the EEPROM 18 and NVRAM 25, respectively, of the image forming apparatus according to the first embodiment of the present invention.

As illustrated in FIG. 2A, in the EEPROM 18, for example, a header 31 is allocated in a region of a few bytes located from the address 0000H, and a data region 32 is allocated next to the header 31 to store the characteristic parameters of the digital scanner 1.

Similarly, as illustrated in FIG. 2B, in the NVRAM 25, for example, a header 41 is allocated in a region of a few bytes located from the address 0000H, and a data region 43 is allocated next to the header 41 to store the characteristic parameters of the digital printer 2.

When the digital scanner 1 is fabricated, the characteristic parameters of the digital scanner 1 are stored in the data region 32, and the initial values of the characteristic parameters are stored in the header 31 of the EEPROM 18.

Similarly, when the digital printer 2 is fabricated, the characteristic parameters of the digital printer 2 are stored in the data region 43, and the initial values of the characteristic parameters are stored in the header 41 of the NVRAM 25.

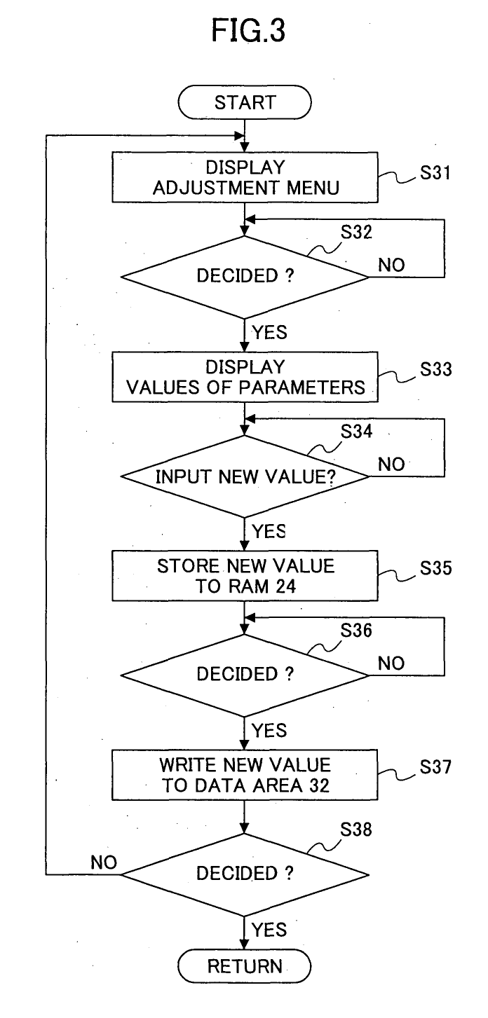

FIG. 3 is a flow chart showing an example of the operation of the image forming apparatus according to the first embodiment of the present invention. Specifically, FIG. 3 shows the procedure for adjusting values of the parameters of the digital scanner 1 when the digital scanner 1 is connected to the digital printer 2 as an option after the digital scanner 1 and the digital printer 2 are shipped and in distribution.

As illustrated in FIG. 3, in step S31, a user or a service person operates a panel on the digital printer 2 to select a mode for adjusting the values of the characteristic parameters of the digital scanner 1. Upon that, the CPU 22 receives a signal from the panel indicating selection of the adjustment mode, and based on the signal, the CPU 22 displays a menu on the panel, allowing adjustment of the values of the characteristic parameters of the digital scanner 1.

In step S32, on the panel, the user or the service person selects a parameter of the digital scanner 1 which is to be adjusted.

In step S33, the CPU 22 receives a signal from the panel indicating selection of the desired parameter, and based on the signal, the CPU 22, via the controller 11, reads the selected parameter from the data region 32 of the EEPROM 18, in which the parameters of the digital scanner 1 are stored, and displays the value of the selected parameter on the panel.

In step S34, the user or the service person inputs a new value of the selected parameter of the digital scanner 1 on the panel.

In step S35, the CPU 22 stores the value of the selected parameter input from the panel in the RAM 24 temporarily.

In step S36, the user or the service person is required to confirm that the change of the value of the selected parameter will really be made.

In step S37, when it is confirmed that the change is to be made, the CPU 22 reads the value of parameter temporarily saved in the RAM 24, and writes the value to the address of the selected parameter in the data region 32.

In step S38, after all desired parameters are adjusted following the above steps S31 through S37, the user or the service person is required to make confirmation again, and the adjustment of the characteristic parameters of the digital scanner 1 is completed after the confirmation.

In the above adjustments, when adjusting the values of the characteristic parameter of the digital scanner 1, which is connected to the digital printer 2 to realize a digital duplicating machine after the digital scanner 1 and the digital printer 2 are shipped and in distribution, because the new values of the parameters are stored in the EEPROM 18, which is a nonvolatile storage medium, the new values do not disappear even after the power is turned off, and thus the performance of the digital scanner 1 is ensured.

According to the present embodiment, because the digital printer 2 and the digital scanner 1 are equipped with nonvolatile memories (EEPROM 18 and NVRAM 25), therefore, even after the digital scanner 1 and the digital printer 2 are shipped and in distribution, the function of a digital duplicating machine can be realized by connecting the digital scanner 1 to the digital printer 2.

Second Embodiment

The image forming apparatus of the present embodiment has the same configuration as that described in the first embodiment with reference to FIG. 1. That is, using the same numeral references as in the first embodiment for the same components, the image forming apparatus of the second embodiment includes a digital scanner 1 and a digital printer 2 connected to each other, thus having the function of a digital duplicating machine. The digital scanner 1 has an EEPROM 18, and the digital printer 2 has an NVRAM 25, which are nonvolatile memories.

The image forming apparatus of the present embodiment is different from that in the first embodiment in the aspect that one more data region is allocated in the NVRAM 25 of the digital printer 2 to store the characteristic parameters of the digital scanner 1.

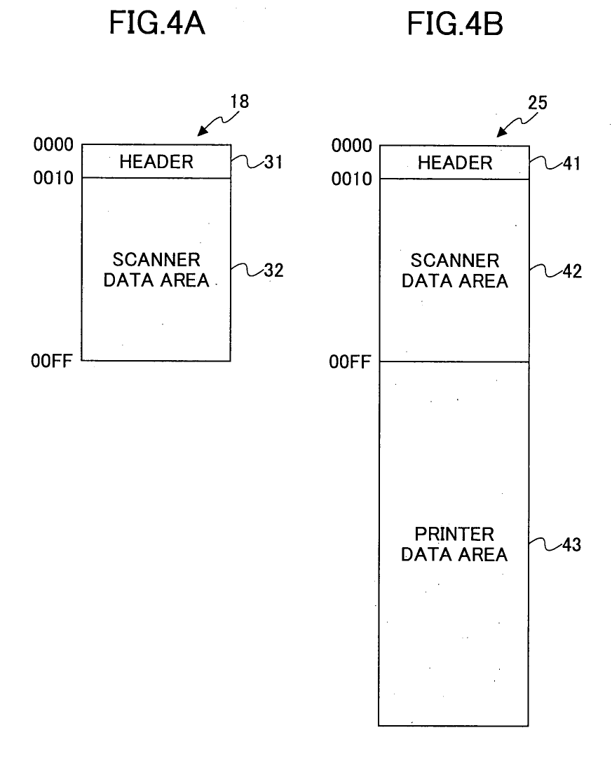

FIGS. 4A and 4B are views of memory maps of the EEPROM 18 and the NVRAM 25, respectively, of the image forming apparatus according to the second embodiment of the present invention.

As illustrated in FIG. 4A, in the EEPROM 18, for example, a header 31 is allocated in a region of a few bytes located from the address 0000H, and a data region 32 is allocated next to the header 31 to store the characteristic parameters of the digital scanner 1.

Similarly, as illustrated in FIG. 4B, in the NVRAM 25, for example, a header 41 is allocated in a region of a few bytes located from the address 0000H. A data region 42 is allocated next to the header 41 for storing the characteristic parameters of the digital scanner 1. Furthermore, a data region 43 is allocated next to the data region 42 for storing the characteristic parameters of the digital printer 2.

In the fabrication process of the digital scanner 1, the characteristic parameters of the digital scanner 1 are stored in the data region 32, and the initial values of the parameters are stored in the header 31 in the EEPROM 18.

Similarly, in the fabrication process of the digital printer 2, the characteristic parameters of the digital printer 2 are stored in the data region 43, and the initial values of the parameters are stored in the header 41 in the NVRAM 25. In the fabrication process of the digital printer 2, the data region 42 contains only certain initial values.

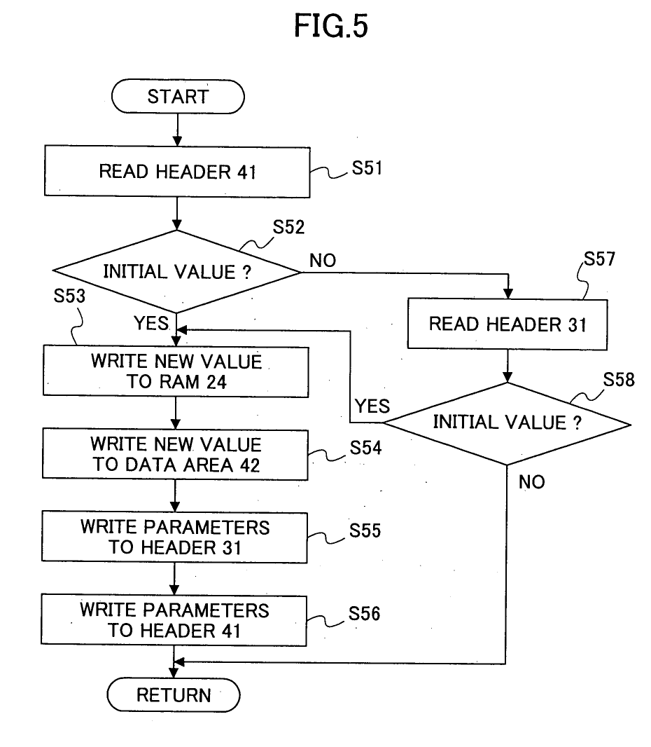

FIG. 5 is a flow chart showing an example of the operation of the above image forming apparatus according to the present embodiment when power is turned on to start the image forming apparatus. One typical case as shown in FIG. 5 is the case in which the control section of the digital scanner 1 including the EEPROM 18 is exchanged, and thus, the characteristic parameters of the digital printer 2 have been written into the header 41 of the NVRAM 25, but the data in the header 31 of the EEPROM 18 are still the initial values of the digital scanner 1.

In step S51, when it is confirmed that the digital scanner 1 has been connected to the digital printer 2, the CPU 22 reads data from the header 41 of the NVRAM 25.

In step S52, the CPU 22 confirms whether the data read from the header 41 are the initial values of the parameters of the digital printer 2.

If the data read from the header 41 are the initial values of the parameters of the digital printer 2, the routine proceeds to step S53, otherwise, the routine proceeds to step S57.

In step S53, the CPU 22, via the controller 11, reads values of the characteristic parameters of the digital scanner 1 from the data region 32 in the EEPROM 18, and saves the data to the RAM 24.

In step S54, the CPU 22 writes the values of the characteristic parameters of the digital scanner 1 saved in the RAM 24 to the data region 42 of the NVRAM 25.

In step S55, the CPU 22 writes the values of the characteristic parameters of the digital scanner 1 to the header 31 of the EEPROM 18 through the controller 11.

In step S56, at the same time with the step S55, the CPU 22 also writes the values of the characteristic parameters of the digital printer 2 to the header 41. After that, the routine is completed.

In step S57, if the data read from the header 41 are not the initial values of the parameters of the digital printer 2, the CPU 22 reads data from the header 31 in the EEPROM 18 through the controller 11.

In step S58, the CPU 22 confirms whether the data read from the header 31 are the initial values of the parameters of the digital scanner 1. If they are, the routine proceeds to step S53, and the operations in steps S53 through S56 are executed as described above. Otherwise, the routine is completed.

By the above process, the characteristic parameters of the digital scanner 1 can be stored in the digital printer 2 in advance.

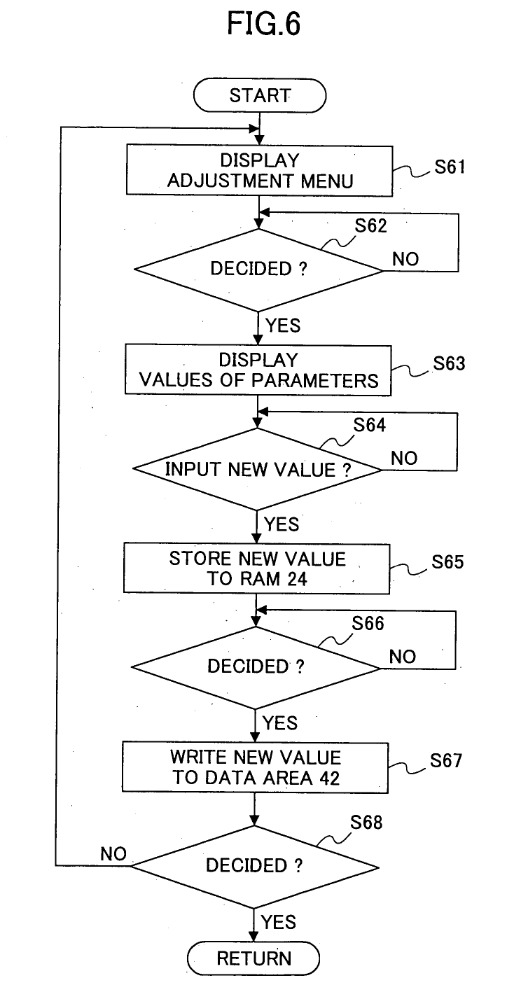

FIG. 6 is a flow chart showing another example of the operation of the image forming apparatus according to the present embodiment. Specifically, FIG. 6 shows the procedure for adjusting values of the parameters of the digital scanner 1 when the digital scanner 1 is connected to the digital printer 2 as an option after the digital scanner 1 and the digital printer 2 are shipped and in distribution.

As illustrated in FIG. 6, in step S61, a user or a service person operates a panel on the digital printer 2 to select a mode for adjusting the values of the characteristic parameters of the digital scanner 1. Upon that, the CPU 22 receives a signal from the panel indicating selection of the adjustment mode, and based on the signal, the CPU 22 displays a menu on the panel, allowing adjustment of the values of the characteristic parameters of the digital scanner 1.

In step S62, on the panel, the user or the service person selects a parameter of the digital scanner 1 which is to be adjusted.

In step S63, the CPU 22 receives a signal from the panel indicating selection of the desired parameter, and based on the signal, the CPU 22, via the controller 11, reads, the selected parameter from the data region 42 of the NVRAM 25, in which the parameters of the digital scanner 1 are stored, and displays the value of the selected parameter on the panel.

In step S64, the user or the service person inputs a new value of the selected parameter of the digital scanner 1 on the panel.

In step S65, the CPU 22 stores the value of the selected parameter input from the panel to the RAM 24 temporarily.

In step S66, the user or the service person is required to confirm that the change of the value of the selected parameter will really be made.

In step S67, when it is confirmed that the change is to be made, the CPU 22 reads the value of parameter temporarily saved in the RAM 24, and writes the value to the address of the selected parameter in the data region 42.

In step S68, after all desired parameters are adjusted following the above steps S61 through S67, the user or the service person is required to make confirmation again, and the adjustment of the characteristic parameters of the digital scanner 1 is completed after the confirmation.

Because of the above adjustments, when the digital printer 2 and the digital scanner 1 are connected to realize the function of a digital duplicating machine after the digital scanner 1 and the digital printer 2 are shipped and in distribution, it is possible to perform memory management for both the digital printer 2 and the digital scanner 1 on the digital printer 2 side.

According to the present embodiment, when a digital scanner 1 is newly connected to the digital printer 2, because the data of the characteristic parameters in the EEPROM 18 of the digital scanner 1 can be stored in the NVRAM 25 of the digital printer 2, memory management for the digital printer 2 and the digital scanner 1 can be performed on the side of the digital printer 2. In addition, when modifying the values of the parameters, because the corrected values can also be stored in the NVRAM 25 of the digital printer 2, the performance of the digital scanner 1 is ensured.

Third Embodiment

The image forming apparatus of the present embodiment has the same configuration as that described in the first embodiment with reference to FIG. 1. That is, using the same numeral references as in the first embodiment for the same components, the image forming apparatus of the present embodiment includes a digital scanner 1 and a digital printer 2 connected to each other, thus having the function of a digital duplicate machine. The digital scanner 1 has an EEPROM 18, and the digital printer 2 has an NVRAM 25, which are nonvolatile memories.

Furthermore, as illustrated in FIGS. 4A and 4B, a header 31 is allocated in the EEPROM 18, and a data region 32 is allocated next for storing the characteristic parameters of the digital scanner 1; a header 41 is allocated in the NVRAM 25, and a data region. 42 and a data region 43 are allocated in order for storing the characteristic parameters of the digital scanner 1 and the characteristic parameters of the digital printer 2, respectively. Moreover, the characteristic parameters of the digital scanner 1 are stored into the data region 32, and the initial values of the parameters are stored in the header 31 in the EEPROM 18 in the fabrication process of the digital scanner 1; and the characteristic parameters of the digital printer 2 are stored in the data region 43, and the initial values of the parameters are stored in the header 41 in the NVRAM 25 in the fabrication process of the digital printer 2. Further, the data region 42 contains certain initial values in fabrication.

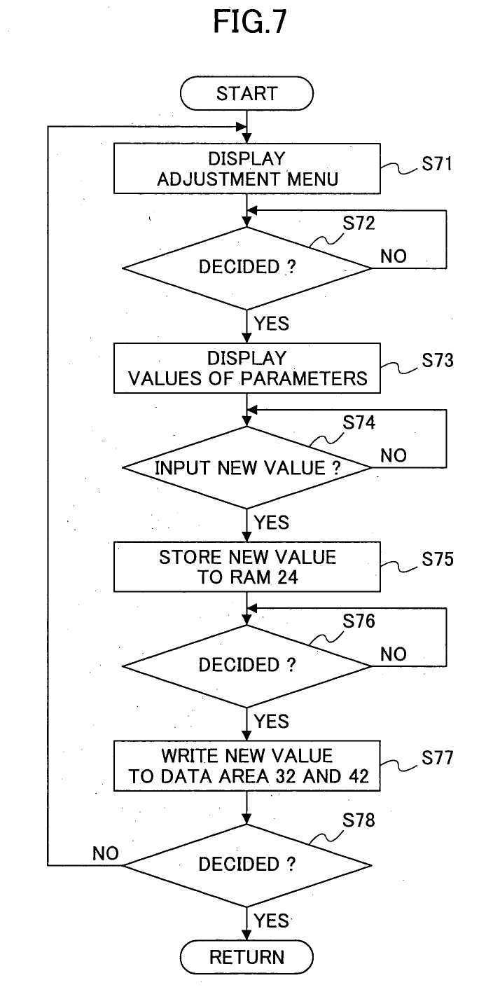

FIG. 7 is a flow chart showing an example of the operation of the image forming apparatus according to the third embodiment of the present invention. Specifically, FIG. 7 shows the procedure for adjusting values of the parameters of the digital scanner 1 when the digital scanner 1 is connected to the digital printer 2 as an option after the digital scanner 1 and the digital printer 2 are shipped and in distribution.

As illustrated in FIG. 7, in step S71, a user or a service person operates a panel on the digital printer 2 to select a mode for adjusting the values of the characteristic parameters of the digital scanner 1. Upon that, the CPU 22 receives a signal from the panel indicating selection of the adjustment mode, and based on the signal, the CPU 22 displays a menu on the panel, allowing adjustment of the values of the characteristic parameters of the digital scanner 1.

In step S72, on the panel, the user or the service person selects a parameter of the digital scanner 1 which is to be adjusted.

In step S73, the CPU 22 receives a signal from the panel indicating selection of the desired parameter, and based on the signal, the CPU 22, via the controller 11, reads the selected parameter from the data region 42 of the NVRAM 25, in which the parameters of the digital scanner 1 are stored, and displays the value of the selected parameter on the panel.

In step S74, the user or the service person inputs a new value of the selected parameter of the digital scanner 1 on the panel.

In step S75, the CPU 22 stores the value of the selected parameter input from the panel to the RAM 24 temporarily.

In step S76, the user or the service person is required to confirm that the change of the value of the selected parameter will really be made.

In step S77, when it is confirmed that the change is to be made, the CPU 22 reads the value of parameter temporarily saved in the RAM 24, and writes the value to the address of the selected parameter in the data region 42 of the NVRAM 25, and to the address of the parameter in the data region 32 of the EEPROM 18.

In step S78, after all desired parameters are adjusted following the above steps S71 through S77, the user or the service person is required to make confirmation again, and the adjustment of the characteristic parameters of the digital scanner 1 is completed after the confirmation.

Because of the above adjustments, when the digital printer 2 and the digital scanner 1 are connected to realize the function of a digital duplicating machine after the digital scanner 1 and the digital printer 2 are shipped and in distribution, it is possible to manage data stored in memories of both the digital printer 2 and the digital scanner 1 on the side of the digital printer 2, and in addition, the adjusted parameters can also be stored in the digital scanner 1. As a result, it is not necessary to adjust the characteristic parameters of the digital scanner 1 again even when the digital scanner 1 is connected to a different digital printer 2.

According to the present embodiment, in a digital duplicating machine including the digital scanner 1 and the digital printer 2 which are connected to each other, when the values of the characteristic parameters of the digital scanner 1 are changed, the new values of the characteristic parameters are stored in both the EEPROM 18 of the digital scanner 1 and the NVRAM 25 of the digital printer 2, and therefore, memory management can be performed from the side of the digital printer 2, and the performance of the digital scanner 1 is ensured. Furthermore, compatibility of the digital scanner 1 is ensured even when a different digital scanner is connected to the digital printer 2.

Fourth Embodiment

The image forming apparatus of the present embodiment has the same configuration as that described in the first embodiment with reference to FIG. 1. That is, using the same numeral references as in the first embodiment for the same components, the image forming apparatus of the present embodiment includes a digital scanner 1 and a digital printer 2 connected to each other, thus having the function of a digital duplicating machine. The digital scanner 1 has an EEPROM 18, and the digital printer 2 has an NVRAM 25, which are nonvolatile memories.

The image forming apparatus of the present embodiment is different from those of the previous embodiments in the aspect that corrections to the original values of the characteristic parameters of the digital scanner 1 are stored in the NVRAM 25.

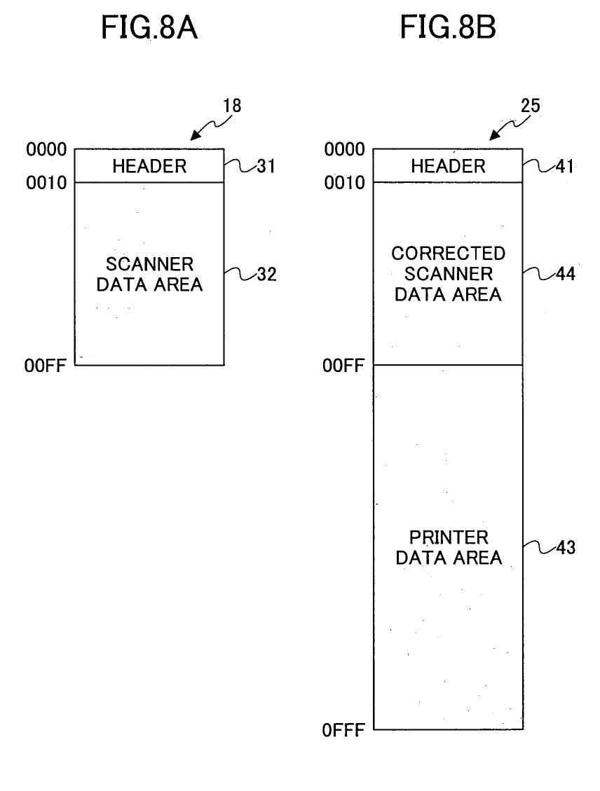

FIGS. 8A and 8B are views of memory maps of the EEPROM 18 and NVRAM 25 of the image forming apparatus according to the fourth embodiment of the present invention.

As illustrated in FIG. 8A, in the EEPROM 18, for example, a header 31 is allocated in a region of a few bytes located from the address 0000H, and a data region 32 is allocated next to the header 31 to store the characteristic parameters of the digital scanner 1.

Similarly, as illustrated in FIG. 8B, in the NVRAM 25, for example, a header 41 is allocated in a region of a few bytes located from the address 0000H, and a data region 44 is allocated next to the header 41 to store the corrections to the original values of the characteristic parameters of the digital scanner 1. Furthermore, a data region 43 is allocated next to the data region 44 for storing the characteristic parameters of the digital printer 2.

In the fabrication process of the digital scanner 1, the characteristic parameters of the digital scanner 1 are stored in the data region 32, and the initial values of the parameters are stored in the header 31 in the EEPROM 18.

Similarly, in the fabrication process of the digital printer 2, the characteristic parameters of the digital printer 2 are stored in the data region 43, and the initial values of the parameters are stored in the header 41 in the NVRAM 25. The initial values of the data region 44 are zero.

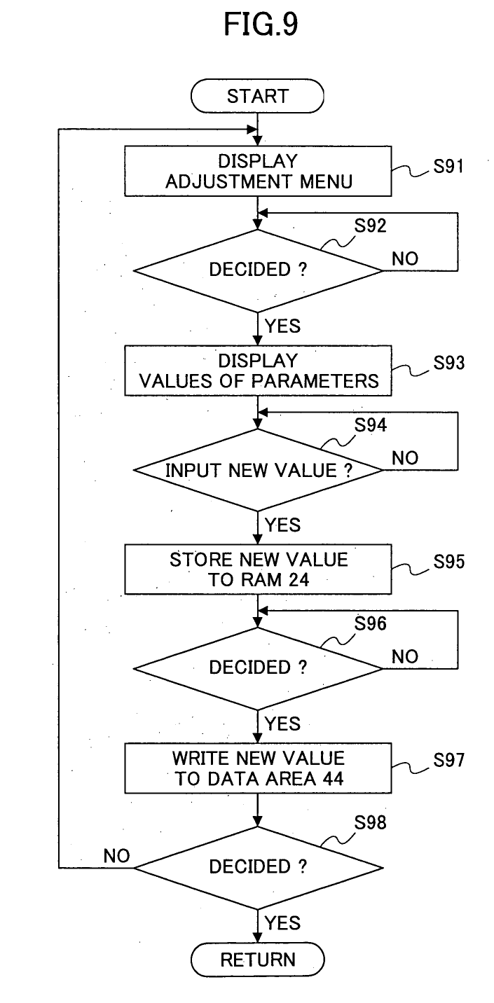

FIG. 9 is a flow chart showing an example of the operation of the image forming apparatus according to the fourth embodiment of the present invention. Specifically, FIG. 9 shows the procedure for adjusting values of the parameters of the digital scanner 1 when the digital scanner 1 is connected to the digital printer 2 as an option after the digital scanner 1 and the digital printer 2 are shipped and in distribution.

As illustrated in FIG. 9, in step S91, a user or a service person operates a panel on the digital printer 2 to select a mode for adjusting the values of the characteristic parameters of the digital scanner 1. Upon that, the CPU 22 receives a signal from the panel indicating selection of the adjustment mode, and based on the signal, the CPU 22 displays a menu on the panel, allowing adjustment of the values of the characteristic parameters of the digital scanner 1.

In step S92, on the panel, the user or the service person selects a parameter of the digital scanner 1 which is to be adjusted.

In step S93, the CPU 22 receives a signal from the panel indicating selection of the desired parameter, and based on the signal, the CPU 22, via the controller 11, reads the selected parameter from the data region 32 of the EEPROM 18, in which the parameters of the digital scanner 1 are stored. In addition, the CPU 22 reads the correction to the original value of the selected parameter from the data region 44 of the NVRAM 25, and makes calculations using the original value of the selected parameter and the correction to the original value, and the result is used as the present value of the selected parameter. Then the CPU 22 displays the present value of the selected parameter on the panel.

Here, the calculation made by the CPU 22 may be the summation of the original value of the selected parameter stored in the EEPROM 18 and the correction to the original value of the selected parameter stored in NVRAM 25, this sum giving the present value of the selected parameter.

In step S94, the user or the service person inputs a new value of the selected parameter of the digital scanner 1 on the panel.

In step S95, the CPU 22 calculates the difference between the new value of the selected parameter input from the panel and the value of the selected parameter stored in the EEPROM 18, and stores the difference in the RAM 24 temporarily as the correction.

In step S96, the user or the service person is required to confirm that the change of the value of the selected parameter will really be made.

In step S97, when it is confirmed that the change is to be made, the CPU 22 reads the correction to the parameter temporarily saved in the RAM 24, and writes the value of the correction to the corresponding address in the data region 44 of the NVRAM 25.

In step S98, after all desired parameters are adjusted in the same way following the above steps S91 through S97, the user or the service person is required to make confirmation again, and the adjustment of the characteristic parameters of the digital scanner 1 is completed after the confirmation.

Because of the above adjustments, when adjusting the characteristic parameters of the digital scanner 1 which is connected to the digital printer 2 to realize the function of a digital duplicating machine after the digital scanner 1 and the digital printer 2 are shipped and in distribution, it is not necessary to modify the original values of the characteristic parameters of the digital scanner 1 determined in the factory, but just store the corrections to the original values in the NVRAM 25 of the digital printer 2. Therefore it is possible to maintain compatibility even when the digital scanner 1 is changed. Further, it is not necessary to adjust again the values of the characteristic parameters of the digital scanner 1, and the values of the characteristic parameters determined previously based on the combination of the digital printer 2 and the former digital scanner 1 are still usable.

According to the present embodiment, in a digital duplicating machine including the digital scanner 1 and the digital printer 2 that are connected to each other, because only the corrections to the original values are stored in the NVRAM 25 of the digital printer 2, the performance of the digital scanner 1 is ensured. Furthermore, because values of the characteristic parameters determined in the factory are stored in the EEPROM 18 of the digital scanner 1, compatibility of the digital scanner 1 is ensured even when a different digital scanner is connected to the digital printer 2.

Fifth Embodiment

The image forming apparatus of the present embodiment has the same configuration as that described in the first embodiment with reference to FIG. 1. That is, using the same numeral references as in the first embodiment for the same components, the image forming apparatus of the present embodiment includes a digital scanner 1 and a digital printer 2 connected to each other, thus having the function of a digital duplicating machine. The digital scanner 1 has an EEPROM 18, and the digital printer 2 has an NVRAM 25, which are nonvolatile memories.

However, the image forming apparatus of the present embodiment is different from those of the previous embodiments in the aspect that both the original values and the corrections to the original values of the characteristic parameters of the digital scanner 1 are stored in the NVRAM 25.

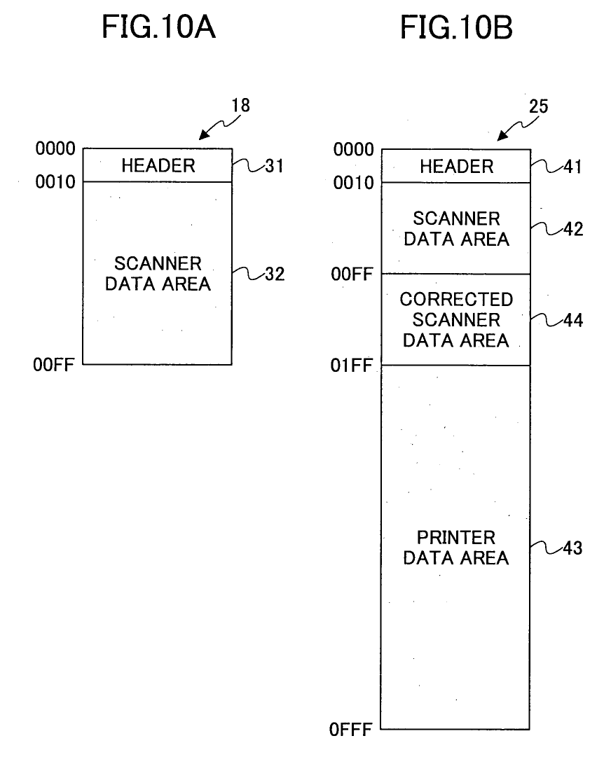

FIGS. 10A and 10B are views of memory maps of the EEPROM 18 and NVRAM 25, respectively, of the image forming apparatus according to the fifth embodiment of the present invention.

As illustrated in FIG. 10A, in the EEPROM 18, for example, a header 31 is allocated in a region of a few bytes located from the address 0000H, and a data region 32 is allocated next to the header 31 to store the characteristic parameters of the digital scanner 1.

Similarly, as illustrated in FIG. 10B, in the NVRAM 25, for example, a header 41 is allocated in a region of a few bytes located from the address 0000H, and data regions 42, 44, and 43 are allocated next to the header 41 in order. The data regions 42 and 44 are used to store the original values and the corrections to the original values, respectively, of the characteristic parameters of the digital scanner 1. The data region 43 is used to store the characteristic parameters of the digital printer 2.

In the fabrication process of the digital scanner 1, the characteristic parameters of the digital scanner 1 are stored in the data region 32, and the initial values of the parameters are stored in the header 31 in the EEPROM 18.

Similarly, in the fabrication process of the digital printer 2, the characteristic parameters of the digital printer 2 are stored in the data region 43, and the initial values of the parameters are stored in the header 41 in the NVRAM 25. The initial values of the data region 44 are zero. In addition, the initial values of the characteristic parameters of the digital scanner 1 are stored in the data region 42 when the digital printer 2 is fabricated, and when the digital scanner 1 is connected to the digital printer 2, data of the characteristic parameters of the digital scanner 1 stored in the data region 32 of the EEPROM 18 are transferred to the data region 42, as described in the second embodiment.

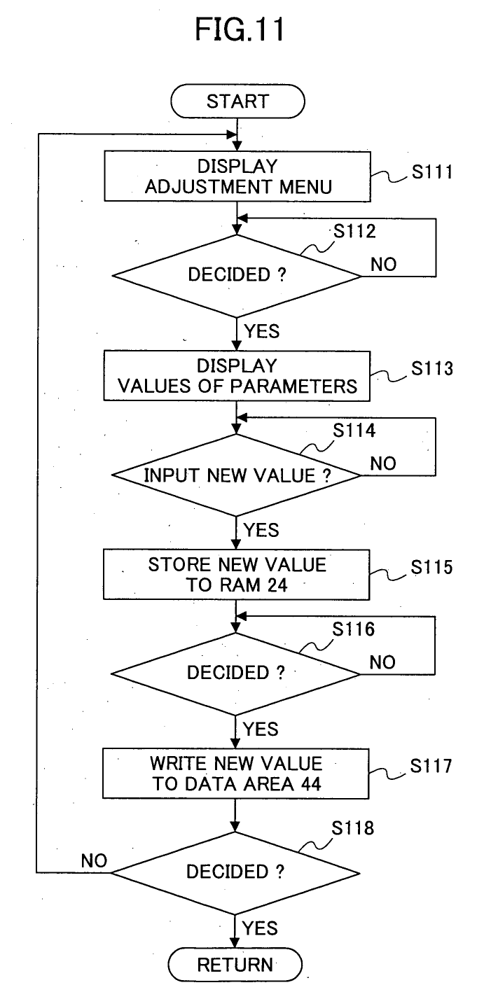

FIG. 11 is a flow chart showing an example of the operation of the image forming apparatus according to the fifth embodiment of the present invention. Specifically, FIG. 11 shows the procedure for adjusting values of the parameters of the digital scanner 1 when the digital scanner 1 is connected to the digital printer 2 as an option after the digital scanner 1 and the digital printer 2 are shipped and in distribution.

As illustrated in FIG. 11, in step S111, a user or a service person operates a panel on the digital printer 2 to select a mode for adjusting the values of the characteristic parameters of the digital scanner 1. Upon that, the CPU 22 receives a signal from the panel indicating selection of the adjustment mode, and based on the signal, the CPU 22 displays a menu on the panel, allowing adjustment of the values of the characteristic parameters of the digital scanner 1.

In step S112, on the panel, the user or the service person selects a parameter of the digital scanner 1 which is to be adjusted.

In step S113, the CPU 22 receives a signal from the panel indicating selection of the desired parameter, and based on the signal, the CPU 22 reads the selected parameter from the data region 42 of the NVRAM 25, in which the parameters of the digital scanner 1 are stored, and reads the correction to the original value of the selected parameter from the data region 44 of the NVRAM 25. The CPU 22 makes calculations using the original value of the selected parameter and the correction to the original value, and the result is used as the present value of the selected parameter. Then the CPU 22 displays the present value of the selected parameter on the panel.

For example, the calculation made by the CPU 22 may be the summation of the original value of the selected parameter stored in the data region 42 and the correction to the original value of the selected parameter stored in the data region 44 of the NVRAM 25, this sum giving the present value of the selected parameter.

In step S114, the user or the service person inputs a new value of the selected parameter of the digital scanner 1 on the panel.

In step S115, the CPU 22 calculates the difference between the new value of the selected parameter input from the panel and the value of the selected parameter stored in the data region 42 of the NVRAM 25, and stores the difference in the RAM 24 temporarily as the correction.

In step S116, the user or the service person is required to confirm that the change of the value of the selected parameter will really be made.

In step S117, when it is confirmed that the change is to be made, the CPU 22 reads the correction to the parameter temporarily saved in the RAM 24, and writes the value of the correction to the corresponding address in the data region 44 of the NVRAM 25.

In step S118, after all desired parameters are adjusted in the same way following the above steps S111 through S117, the user or the service person is required to make confirmation again, and the adjustment of the characteristic parameters of the digital scanner 1 is completed after the confirmation.

Because of the above adjustments, when the digital printer 2 and the digital scanner 1 are connected to realize the function of a digital duplicating machine, it is possible to perform memory management for both the digital printer 2 and the digital scanner 1 on the digital printer 2 side.

According to the present embodiment, in a digital duplicating machine including the digital scanner 1 and the digital printer 2 that are connected toh each other, when the characteristic parameters of the digital scanner 1 are modified, because only the corrections to the original values are stored in the NVRAM 25 of the digital printer 2, the performance of the digital scanner 1 is ensured, and because values of the characteristic parameters determined in the factory are stored in the EEPROM 18 of the digital scanner 1 and the NVRAM 25, compatibility of the digital scanner 1 is ensured even when the digital scanner is connected to a different digital printer 2.

Sixth Embodiment

The image forming apparatus of the present embodiment has the same configuration as that described in the first embodiment with reference to FIG. 1. That is, using the same numeral references as in the first embodiment for the same components, the image forming apparatus of the present embodiment includes a digital scanner 1 and a digital printer 2 connected to each other, thus having the function of a digital duplicating machine. The digital scanner 1 has an EEPROM 18, and the digital printer 2 has an NVRAM 25, which are nonvolatile memories.

However, the image forming apparatus of the present embodiment is different from those of the previous embodiments in the aspect that the original values and the corrections to the original values of the characteristic parameters of the digital scanner 1 are stored in both the EEPROM 18 and the NVRAM 25.

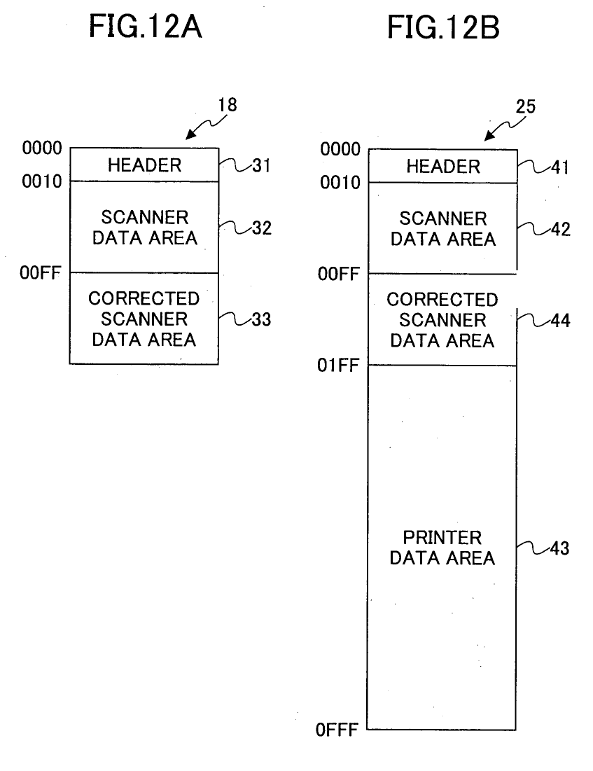

FIGS. 12A and 12B are views of memory maps of the EEPROM 18 and NVRAM 25 of the image forming apparatus according to the sixth embodiment of the present invention.

As illustrated in FIG. 12A, in the EEPROM 18, for example, a header 31 is allocated in a region of a few bytes located from the address 0000H, and a data region 32 is allocated next to the header 31 to store the original values of the characteristic parameters of the digital scanner 1. Furthermore, a data region 33 is allocated next to the data region 32 to store the corrections to the original values of the characteristic parameters of the digital scanner 1.

Similarly, as illustrated in FIG. 12B, in the NVRAM 25, for example, a header 41 is allocated in a region of a few bytes located from the address 0000H, and data regions 42, 44, and 43 are allocated next to the header 41 in order. The data regions 42 and 44 are used to store the original values and the corrections to the original values, respectively, of the characteristic parameters of the digital scanner 1; the data region 43 is used to store the characteristic parameters of the digital printer 2.

In the fabrication process of the digital scanner 1, the characteristic parameters of the digital scanner 1 are stored in the data region 32, and the initial values of the parameters are stored in the header 31 in the EEPROM 18. The initial values of the data region 33 are zero.

Similarly, in the fabrication process of the digital printer 2, the characteristic parameters of the digital printer 2 are stored in the data region 43, and the initial values of the parameters are stored in the header 41 in the NVRAM 25. The initial values of the data region 44 are zero. In addition, the initial values of the characteristic parameters of the digital scanner 1 are stored in the data region 42 when the digital printer 2 is shipped, and when the digital scanner 1 is connected to the digital printer 2, data of the characteristic parameters of the digital scanner 1 stored in the data region 32 of the EEPROM 18 are transferred to the data region 42, as described in the second embodiment.

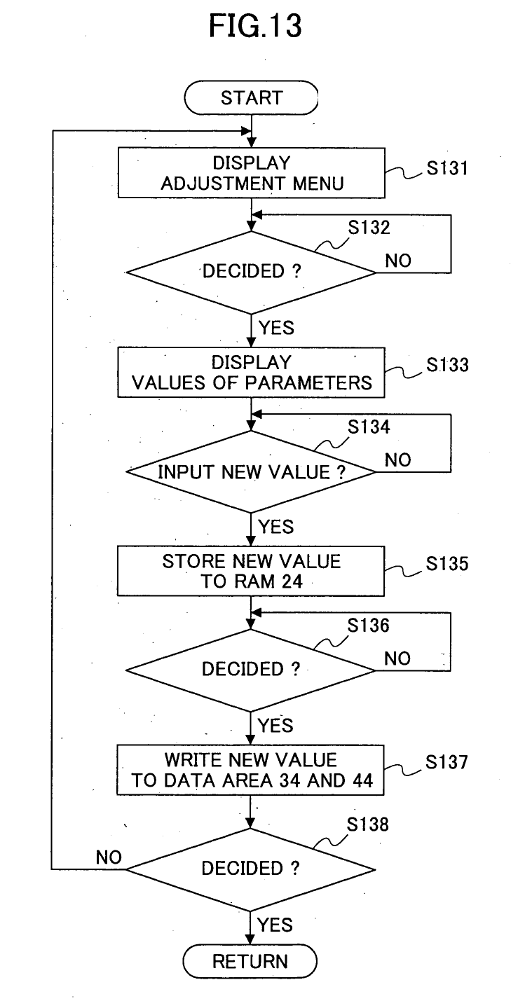

FIG. 13 is a flow chart showing an example of the operation of the image forming apparatus according to the fifth embodiment of the present invention. Specifically, FIG. 13 shows the procedure for adjusting values of the parameters of the digital scanner 1 when the digital scanner 1 is connected to the digital printer 2 as an option after the digital scanner 1 and the digital printer 2 are shipped and in distribution.

As illustrated in FIG. 13, in step S131, a user or a service person operates a panel on the digital printer 2 to select a mode for adjusting the values of the characteristic parameters of the digital scanner 1. Upon that, the CPU 22 receives a signal from the panel indicating selection of the adjustment mode, and based on the signal, the CPU 22 displays a menu on the panel, allowing adjustment of the values of the characteristic parameters of the digital scanner 1.

In step S132, on the panel, the user or the service person selects a parameter of the digital scanner 1 which is to be adjusted.

In step S133, the CPU 22 receives a signal from the panel indicating selection of the desired parameter, and based on the signal, the CPU 22 reads the selected parameter from the data region 42 of the NVRAM 25, in which the parameters of the digital scanner 1 are stored, and reads the correction to the original value of the selected parameter from the data region 44 of the NVRAM 25. The CPU 22 makes calculations using the original value of the selected parameter and the correction to the original value, and the result is used as the present value of the selected parameter. Then the CPU 22 displays the present value of the selected parameter on the panel.

For example, the calculation made by the CPU 22 may be the summation of the original value of the selected parameter stored in the data region 42 and the correction to the original value of the selected parameter stored in the data region 44 of the NVRAM 25, this sum giving the present value of the selected parameter.

In step S134, the user or the service person inputs a new value of the selected parameter of the digital scanner 1 on the panel.

In step S135, the CPU 22 calculates the difference between the new value of the selected parameter input from the panel and the value of the selected parameter stored in the data region 42 of the NVRAM 25, and temporarily stores the difference in the RAM 24 as the correction to the parameter.

In step S136, the user or the service person is required to confirm that the change of the value of the selected parameter will really be made.

In step S137, when it is confirmed that the change is to be made, the CPU 22 reads the correction to the parameter temporarily saved in the RAM 24, and writes the value of the correction to the corresponding address in the data region 44 of the NVRAM 25, and to the corresponding address in the data region 33 of the EEPROM 18.

In step S138, after all desired parameters are adjusted in the same way following the above steps S131 through S137, the user or the service person is required to make confirmation again, and the adjustment of the characteristic parameters of the digital scanner 1 is completed after the confirmation.

Because of the above adjustments, when the digital printer 2 and the digital scanner 1 are connected to realize the function of a digital duplicating machine, because the corrections to the characteristic parameters of the digital scanner 1 are stored in both the digital scanner 1 and the digital printer 2, it is possible to maintain compatibility even when either the digital scanner 1 or the digital printer 2 is changed.

According to the present embodiment, when a digital scanner 1 is newly connected to the digital printer 2, because the data of the characteristic parameters of the digital scanner 1 are stored in the NVRAM 25 of the digital printer 2, memory management for the digital printer 2 and the digital scanner 1 can be performed on the side of the digital printer 2. In addition, when the values of the parameters of the digital scanner 1 are modified, because the corrections to the original values can be stored in both the NVRAM 25 of the digital printer 2 and the EEPROM 18 of the digital scanner 1, the performance of the digital scanner 1 is ensured. Furthermore, because values of the characteristic parameters of the digital scanner 1 determined in the factory are stored in the EEPROM 18 of the digital scanner 1, compatibility of the digital scanner 1 is ensured even when the digital scanner is connected to a different digital printer 2. In addition, new adjustment of the parameters of the digital scanner 1 is not needed even if a digital scanner 1 is newly connected to a digital printer 2.

While the present invention has been described with reference to specific embodiments chosen for purpose of illustration, it should be apparent that the invention is not limited to these embodiments, but numerous modifications could be made thereto by those skilled in the art without departing from the basic concept and scope of the invention.

For example, the present invention is applicable to any kind of image forming apparatus, such as a fax machine as well as a digital printer, to which a digital scanner can be connected when necessary.

Summarizing the effect of the present invention, because the digital printing device and the digital scanning device are equipped with nonvolatile memories, the functions of a digital duplicating machine can be realized by connecting the digital scanning device to the digital printing device even when the devices are in distribution after their shipment.

In addition, because the data of the characteristic parameters of the digital scanning device are stored in the nonvolatile memory of the digital printing device, memory management for the two devices can be performed on the side of the digital printing device, and the performance of the digital scanning device is ensured. In addition, compatibility of the performance of the digital scanning device is ensured even when a different digital scanner is connected to the digital printer 2.

In addition, compatibility of the performance of the digital scanning device is ensured even when a different digital scanning device is newly connected to a different digital printing device, or when the digital scanning device is connected to a different digital printing device.

Furthermore, it is not necessary to adjust values of the characteristic parameters of the digital scanning device, even when the digital scanning device is newly connected to the digital printing device.

This patent application is based on Japanese priority patent application No. 2002-193658 filed on Jul. 2, 2002, the entire contents of which are hereby incorporated by reference.

What is claimed is:

1. An image forming apparatus, comprising:
a digital printing device that prints an image according to image signals input thereto, the digital printing device including a first nonvolatile memory for storing first parameters that optimize performance thereof; and
a digital scanning device, connectable to the digital printing device, that scans an image and converts the image into electric signals, the digital scanning device including a second nonvolatile memory for storing second parameters that optimize performance thereof,
wherein
the digital printing device includes control means for modifying the second parameters when the digital scanning device is connected to the digital printing device.

2. The image forming apparatus as claimed in claim 1, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing the modified second parameters to the second nonvolatile memory of the digital scanning device when the digital scanning device is connected to the digital printing device.

3. The image forming apparatus as claimed in claim 1, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing the modified second parameters to the first nonvolatile memory of the digital printing device and the second nonvolatile memory of the digital scanning device when the digital scanning device is connected to the digital printing device.

4. The image forming apparatus as claimed in claim 1, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing values equal to the modifications made by the modification means to the second nonvolatile memory of the digital scanning device when the digital scanning device is connected to the digital printing device.

5. The image forming apparatus as claimed in claim 1, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing values equal to the modifications made by the modification means to the first nonvolatile memory of the digital printing device and the second nonvolatile memory of the digital scanning device when the digital scanning device is connected to the digital printing device.

6. An image forming apparatus, comprising:
a digital printing device that prints an image according to image signals input thereto, the digital printing device including a first nonvolatile memory for storing first parameters that optimize performance thereof; and
a digital scanning device, connectable to the digital printing device, that scans an image and converts the image into electric signals, the digital scanning device including a second nonvolatile memory for storing second parameters that optimize performance thereof,
wherein
the digital printing device includes a control unit configured to modify the second parameters when the digital scanning device is connected to the digital printing device.

7. The image forming apparatus as claimed in claim 6, wherein the control unit comprises:
a reading unit configured to read the second parameters stored in the second nonvolatile memory of the digital scanning device when the digital scanning device is connected to the digital printing device;
a modification unit configured to modify the second parameters read by the reading unit; and
a writing unit configured to write the modified second parameters to the second nonvolatile memory of the digital scanning device when the digital scanning device is connected to the digital printing device.

8. The image forming apparatus as claimed in claim 6, wherein the control unit comprises:
a reading unit configured to read the second parameters stored in the second nonvolatile memory of the digital scanning device when the digital scanning device is connected to the digital printing device;
a modification unit configured to modify the second parameters read by the reading unit; and
a writing unit configured to write the modified second parameters to the first nonvolatile memory of the digital printing device and the second nonvolatile memory of the digital scanning device when the digital scanning device is connected to the digital printing device.

9. The image forming apparatus as claimed in claim 6, wherein the digital printing device comprises:
a reading unit configured to read the second parameters stored in the second nonvolatile memory of the digital scanning device when the digital scanning device is connected to the digital printing device;
a modification unit configured to modify the second parameters read by the reading unit; and
a writing unit configured to write values equaling to the modifications made by the modification unit to the second nonvolatile memory of the digital scanning device when the digital scanning device is connected to the digital printing device.

10. The image forming apparatus as claimed in claim 6, wherein the digital printing device comprises:
a reading unit configured to read the second parameters stored in the second nonvolatile memory of the digital scanning device when the digital scanning device is connected to the digital printing device;
a modification unit configured to modify the second parameters read by the reading unit; and
a writing unit configured to write values equaling to the modifications made by the modification unit to the first nonvolatile memory of the digital printing device and the second nonvolatile memory of the digital scanning device when the digital scanning device is connected to the digital printing device.

11. A digital printing device that prints an image according to image signals input thereto, the digital printing device forming an image forming apparatus when connected with a digital scanning device that scans the image and converts the image into the image signals, the digital printing device including a first nonvolatile memory for storing first parameters that optimize performance thereof, and the digital scanning device including a second nonvolatile memory for storing second parameters that optimize performance thereof,
the digital printing device comprising control means for modifying the second parameters when the digital scanning device is connected to the digital printing device.

12. The digital printing device as claimed in claim 11, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing the modified second parameters to the second nonvolatile memory of the digital scanning device when the digital scanning device is connected to the digital printing device.

13. The digital printing device as claimed in claim 11, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing the modified second parameters to the first nonvolatile memory of the digital printing device and the second nonvolatile memory of the digital scanning device when the digital scanning device is connected to the digital printing device.

14. The digital printing device as claimed in claim 11, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing values equal to the modifications made by the modification means to the second nonvolatile memory of the digital scanning device when the digital scanning device is connected to the digital printing device.

15. The digital printing device as claimed in claim 11, wherein the control means comprise:
reading means for reading the second parameters stored in the second nonvolatile memory of the digital scanning device when the digital scanning device is connected to the digital printing device;
modification means for modifying the second parameters read by the reading means; and
writing means for writing values equal to the modifications made by the modification means to the first nonvolatile memory of the digital printing device and the second nonvolatile memory of the digital scanning device when the digital scanning device is connected to the digital printing device.
